(19) United States
(12) Patent Application Publication
(10) Pub. No.: US 2026/0162044 A1
(43) Pub. Date: Jun. 11, 2026

(54) SYSTEMS AND METHODS FOR GENERATING INDIVIDUALIZED STUDENT TREATMENT STRATEGIES

(71) Applicant: Higher Ground a Resource Center, Tucson, AZ (US)

(72) Inventors: Jansen Azarias, Tucson, AZ (US); Barbara Azarias, Tucson, AZ (US); Rema Hamdan, Tucson, AZ (US)

(21) Appl. No.: 18/970,738

(22) Filed: Dec. 5, 2024

(51) Int. Cl. G06Q 10/0639; G06Q 50/20

(52) U.S. Cl. CPC G06Q 10/06393; G06Q 50/20

(57) ABSTRACT

A system includes: a processor; and a memory storing instructions executed by the processor to cause the processor to: generate a skill area score for each skill area of a plurality of skill areas based on received inputs; identify a skill gap in a skill area of the plurality of skill areas based on the skill area score; determine that the skill gap is an overall skill gap; calculate a building block score for each skill building block of the plurality of skill building blocks associated with the overall skill gap; and generate a recommendation for a strategy corresponding to the identified skill gap based on the building block score.

### FIELD

Aspects of embodiments of the present application relate to systems and methods for generating individualized student treatment strategies, and to systems and methods that utilize machine learning to provide and improve treatment recommendations.

### BACKGROUND

Students may seek help from counselors or coaches to receive guidance and/or ways to navigate issues in their lives. Some of these students may be people who are in need of help, whereas in other cases, they may be people who simply benefit from additional guidance or coaching. In any case, the coaches may come up with an individualized treatment strategy to help the students based on various factors. However, as a person's life experience may include various different factors to be considered for tailoring a suitable plan for the individual, improved techniques for collecting and processing such large amounts of information to generate individualized plans may be desired.

The above information disclosed in this Background section is for enhancement of understanding of the background of the present disclosure, and therefore, it may contain information that does not constitute prior art.

### SUMMARY

Embodiments of the present disclosure may be directed to systems and methods for generating recommendations for treatment strategies to help individuals develop particular skills.

According to one or more embodiments of the present disclosure, a system includes: a processor; and a memory storing instructions executed by the processor to cause the processor to: generate a skill area score for each skill area of a plurality of skill areas based on received inputs; identify a skill gap in a skill area of the plurality of skill areas based on the skill area score; determine that the skill gap is an overall skill gap; calculate a building block score for each skill building block of the plurality of skill building blocks associated with the overall skill gap; and generate a recommendation for a strategy corresponding to the identified skill gap based on the building block score.

In an embodiment, the instructions may further cause the processor to: continuously update the skill area score based on newly received inputs; calculate an overall skill area score by averaging the building block score corresponding to each skill building block associated with the overall skill gap; and calculate a ranking score by averaging the overall skill area score with the skill area score corresponding to the overall skill gap.

In an embodiment, the instructions may further cause the processor to: identify a target development skill based on the ranking score and the building block score.

In an embodiment, the instructions may further cause the processor to: identify the skill area corresponding to the highest ranking score; identify the skill building block corresponding to the lowest building block score from among the plurality of skill building blocks of the identified skill area; and assign the identified skill building block as a recommended skill building block for a target development skill, in response to determining that the identified skill building block is a skill building block related to a number of skill areas of the plurality of skill areas.

In an embodiment, to generate the recommendation for the strategy, the instructions may further cause the one or more processors to: generate a first set of strategies based on the plurality of skill building blocks corresponding to a first criteria; generate a second set of strategies based on the plurality of skill building blocks corresponding to the highest building block score; calculate an adoption rate for each of the strategies generated in the first set of strategies and the second set of strategies; and identify a number of strategies from among the strategies generated in the first set of strategies and the second set of strategies corresponding to the adoption rate being greater than a set adoption rate threshold.

In an embodiment, the instructions may further cause the processor to: calculate a success rate for each of the strategies generated in the first set of strategies and the second set of strategies; and identify a number of strategies from among the identified number of strategies corresponding to the success rate being greater than a set success rate threshold.

In an embodiment, the processor may implement machine learning that may be trained based on datasets corresponding to the adoption rate and the success rates, and the instructions may further cause the processor to: generate the recommendation of the strategy based on at least training and the building block score.

In an embodiment, the dataset corresponding to the adoption rate may be based on a likelihood of a recommendation being an accepted strategy, and the dataset corresponding to the success rate may be based on a likelihood of an adopted strategy being a success.

In an embodiment, the skill areas may include an agency skill area, a grit skill area, and a self-control skill area; the skill area score may include a range of 1.0 to 5.0; and the building block score may include a range of 1.0 to 5.0.

According to one or more embodiments of the present disclosure, a method includes: generating, by a processor, a skill area score for each skill area of a plurality of skill areas based on received inputs; identifying, by the processor, a skill gap in a skill area of the plurality of skill areas based on the skill area score; determining, by the processor, that the skill gap is an overall skill gap; calculating, by the processor, a building block score for each skill building block of the plurality of skill building blocks associated with the overall skill gap; and generating, by the processor, a recommendation for a strategy corresponding to the identified skill gap based on the building block score.

In an embodiment, the method may further include: continuously updating, by the processor, the skill area score based on newly received inputs; calculating, by the processor, an overall skill area score by averaging the building block score corresponding to each skill building block associated with the overall skill gap; and calculating, by the processor, a ranking score by averaging the overall skill area score with the skill area score corresponding to the overall skill gap.

In an embodiment, the method may further include: identifying, by the processor, a target development skill based on the ranking score and the building block score.

In an embodiment, the method may further include: identifying, by the processor, the skill area corresponding to the highest ranking score; identifying, by the processor, the skill building block corresponding to the lowest building block score from among the plurality of skill building blocks of the identified skill area; and assigning, by the processor, the identified skill building block as a recommended skill building block for a target development skill, in response to determining that the identified skill building block is a skill building block for a number of skill areas of the plurality of skill areas.

In an embodiment, the generating of the recommendation for the strategy may include: generating, by the processor, a first set of strategies based on the plurality of skill building blocks corresponding to a first criteria; generating, by the processor, a second set of strategies based on the plurality of skill building blocks corresponding to the highest building block score; calculating, by the processor, an adoption rate for each of the strategies generated in the first set of strategies and the second set of strategies; and identifying, by the processor, a number of strategies from among the strategies generated in the first set of strategies and the second set of strategies corresponding to the adoption rate being greater than a set adoption rate threshold.

In an embodiment, the method may further include: calculating, by the processor, a success rate for each of the strategies generated in the first set of strategies and the second set of strategies; and identifying, by the processor, a number of strategies from among the identified number of strategies corresponding to the success rate being greater than a set success rate threshold.

In an embodiment, the method may further include: training, by the processor, a neural network with a dataset corresponding to the adoption rate and the success rate; and generating, by the processor, the recommendation for the strategy based on at least training of the neural network and the building block score.

In an embodiment, the dataset corresponding to the adoption rate may be based on a likelihood of a strategy being an accepted strategy, and the dataset corresponding to the success rate may be based on a likelihood of an adopted strategy being a success.

In an embodiment, the skill areas may include an agency skill area, a grit skill area, and a self-control skill area; the skill area score may include a range of 1.0 to 5.0; and the building block score may include a range of 1.0 to 5.0.

According to one or more embodiments of the present disclosure, a computer-readable medium storing instructions is provided that, when executed by one or more processors, cause the one or more processors to perform a method including: generating a skill area score for each skill area of a plurality of skill areas based on received inputs; identifying a skill gap in a skill area of the plurality of skill areas based on the skill area score; determining that the skill gap is an overall skill gap; calculating a building block score for each skill building block of the plurality of skill building blocks associated with the overall skill gap; and generating a recommendation for a strategy corresponding to the identified skill gap based on the building block score.

In an embodiment, the one or more processors may implement a continual machine learning method including: observing, by the processor, an implementation of a strategy corresponding to a state of the received inputs; calculating, by the processor, a reward based on the recommendation for the strategy and the implementation of the strategy; and adjusting, by the processor, the recommendation for the strategy for the state of the received inputs based on the reward.

However, the present disclosure is not limited to the above aspects and features. The above and additional aspects and features will be set forth, in part, in the description that follows, and in part, may be apparent from the description, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a diagram of a counseling system according to one or more embodiments.

FIG. 2 depicts examples of a student application GUI, according to one or more embodiments.

FIGS. 3A and 3B depict examples of an application GUI for a coach, according to one or more embodiments.

FIG. 4 is a block diagram of an example counseling platform, according to some embodiments.

FIG. 5 is a flow chart of a method of identifying a gap in a skill, according to one or more embodiments.

FIG. 6 is a block diagram illustrating individual building blocks that make up a building block for each skill area, according to one or more embodiments.

FIGS. 7A and 7B are flow diagrams of a method of selecting a building block skill for skill development, according to one or more embodiments.

FIG. 7C is an example of a table for determining proxy power, according to one or more embodiments of the present disclosure.

FIG. 8 is a flow chart of a method for recommending a plurality of strategies, according to one or more embodiments.

FIG. 9 illustrates a plurality of strategies output to the coach as recommendations from the strategy inference generator, according to one or more embodiments.

FIG. 10 is a block diagram of a machine learning system, according to one or more embodiments.

FIG. 11A-11C are diagrams of various aspects of an artificial neural network system, according to one or more embodiments.

FIG. 12 is a flow chart of a continual machine learning method, according to one or more embodiments.

### DETAILED DESCRIPTION

Aspects of some embodiments of the present disclosure and methods of accomplishing the same may be understood more readily by reference to the detailed description of embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey the aspects of the present disclosure to those skilled in the art. Accordingly, processes, elements, and techniques that are not necessary to those having ordinary skill in the art for a complete understanding of the aspects of the present disclosure may not be omitted.

Unless otherwise noted, like reference numerals, characters, or combinations thereof denote like elements throughout the attached drawings and the written description, and thus, descriptions thereof will not be repeated. Further, parts that are not related to, or that are irrelevant to, the description of the embodiments might not be shown to make the description clear.

Additionally, as those skilled in the art would realize, the described embodiments may be modified in various different ways, all without departing from the spirit or scope of the present disclosure.

In the detailed description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that when an element, layer, region, or component is referred to as being “formed on,” “on,” “connected to,” or “coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or intervening layers, regions, or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

For the purposes of this disclosure, expressions such as “at least one of,” when preceding a list of elements, modify the entire list of elements and do not modify the individual elements of the list. For example, “at least one of X, Y, and Z,” “at least one of X, Y, or Z,” and “at least one selected from the group consisting of X, Y, and Z” may be construed as X only, Y only, Z only, any combination of two or more of X, Y, and Z, such as, for instance, XYZ, XYY, YZ, and ZZ, or any variation thereof. Similarly, the expression such as “at least one of A and B” may include A, B, or A and B. As used herein, the term “and/or” includes any and all combinations of one or more of the associated listed items. For example, the expression such as “A and/or B” may include A, B, or A and B.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

When one or more embodiments may be implemented differently, a specific process order may be performed differently from the described order. For example, two consecutively described processes may be performed substantially at the same time or performed in an order opposite to the described order.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

A student that desires help may come to a coach with a problem and ask for guidance in hopes of overcoming his/her problem. In addition to understanding the problem, a detailed understanding of the student's profile (e.g., personal/familial background, life/school/work experiences, preferences, personality, etc.) should be considered by the coach to generate an individualized treatment strategy. Some techniques for creating treatment strategies may include a process where the coach manually comes up with a treatment strategy using a pen and paper. However, when there is a large amount of information available about the student, it may be difficult for the coach to fully consider every factor of the student's profile when creating the treatment strategy. Thus, while it may seem like two students that have same problems can be treated with the same treatment strategy, all of the other factors should also be taken into account to generate an individualized treatment plan that is specific to each student, as a student may respond differently to treatment based on his/her background, family history, and past experiences. Therefore, a robust computerized approach is desired to consider the numerous factors that are specific to each student to generate an accurate and individualized treatment strategy that is unique and specific to that student, and that would likely be adopted by the student to reach his/her goals. In the present disclosure, the terms “coach” or “counselor” may be used interchangeably and may refer to a practitioner such as a social worker, psychologist, psychiatrist, therapist, teacher, a responsible guardian, and the like, but is not limited thereto.

According to one or more embodiments of the present disclosure, computer systems and methods are provided that may assist counselors, coaches, and the like to collect information from various sources regarding an individual that may be used to generate a suitable individualized treatment strategy for the individual based on various factors, events, experiences, and the like that may uniquely affect the student's ability to learn skills to achieve their goals. For example, in some embodiments, the system may provide a communication platform to enable the students, parents, friends, teachers, mentors, and the like to provide relevant information to the coaches for developing the treatment strategy that is tailored for the individual. In some embodiments, as the individuals improve, they may choose their own treatment strategies for learning particular skills with guidance from the coaches.

In some embodiments, the computer systems and methods may calculate various scores that may be used to generate and provide recommendations and strategies for skill development. For example, the system may take the information collected from the various sources and process the information using a mathematical algorithm to formulate various scores that are used to generate a recommendation for the individualized treatment strategy. Such methodical approach utilizing mathematical algorithms and computerized processes may allow a coach to consider all or most of the numerous factors and elements related to the student, including the information collected from various sources to generate a treatment strategy recommendation that is specifically tailored for the particular student.

In one or more embodiments, the system may be configured to allow caring adults (e.g., adult family members such as parents, grandparents, uncles, aunts, and the like) to engage with students by providing controlled (e.g., limited) access to their profiles, similar to connecting on social media. The students may determine each adult's access level, thereby maintaining confidentiality while sharing the student's struggles and mental states as needed. In some embodiments, the coaches may flag and notify the caring adults if they determine that it may be helpful or necessary, guiding them to build healthier relationships, and offering advice on supporting the student effectively. In one or more embodiments, the system may allow other caring adult professionals with student determination (e.g., medical and behavioral health professionals), to access student data, reducing redundancies and retraumatization during transitions. Thus, according to one or more embodiments of the present disclosure, treating the students using this system may be performed in three phases. For example, in Phase 1, the student's parents, identified through school systems, may gain partial or full access to the system, but can only interact with the coaches, not directly with their child (i.e., the student). In Phase 2, the access may expand to the other caring adults, thereby enabling students to control their profile visibility and receive role-based notifications and support. In Phase 3, advanced AI tools may be introduced for real-time coaching and analysis, thereby helping adults foster stronger relationships with students through tailored guidance and integration with other wellness systems.

In some embodiments, the computer systems and methods may utilize machine learning to improve its recommendations by continual learning based on its recommendations and the actions of the coach in response to the recommendations. Thus, for example, the above-described computer systems and methods may initially generate a recommended individualized treatment strategy based on the various sources of information received regarding the student. However, based on the past treatment and experiences with other help seeking students, the computer system may continually learn valuable information from their treatment, the effectiveness of such treatment strategies, the adoption rate of certain treatment strategies, and the like. Accordingly, machine learning may be leveraged to train the computer systems so that in addition to assessing the student's current situation, the computer systems may also consider historical information from past or ongoing treatments of other students. In some embodiments, the machine learning process may occur continuously so that as information becomes available on the system (e.g., treatment information of others is uploaded to the computer system), the system learns from such training data in real-time.

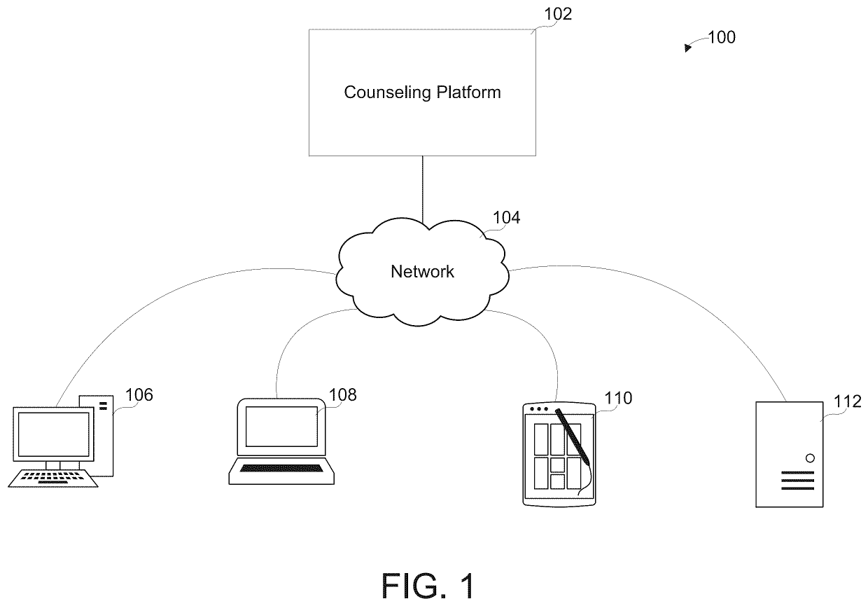

Referring now to the figures, FIG. 1 is a diagram of a counseling system 100 according to one or more embodiments. The system 100 may include any number of systems, devices, or equipment. In one embodiment, the system 100 may include at least a counseling platform 102 connected to a network 104, and one or more other computing devices also connected to the network 104 and are communicable with the counseling platform 102. The computing devices may include, for example, a personal computer such as a desktop computer 106, laptop computer 108, a tablet 110, and/or a server or sub-servers 112 that may be further connected with other computing devices. In some embodiments, the counseling platform 102 may be a computing device including one or more processors, memory, record servers, databases, electronic files, and systems. The counseling platform 102 may also include any number of customized or proprietary systems, software, equipment, devices, or other components that are described herein, which together may be configured to receive, store, and process information about one or more students, and generate an output (e.g., an individualized treatment strategy recommendation), according to one or more embodiments of the present disclosure.

In some embodiments, the counseling platform 102 may be utilized to solicit information about a student to the student's various networks via one or more networks 104. For example, the counseling platform 102 may solicit questionnaires about the student to the student's school network, and the student's teacher or school staff may utilize one or more of the computing devices 106-112 to answer the questionnaires, surveys, and/or provide other information about the student to the counseling platform 102. The computing devices 106-110 may utilize a graphical user interface (GUI) to solicit such questionnaires and survey for ease of use. Similarly, the counseling platform 102 may solicit other questionnaires or surveys to other networks such as, for example, to the student's family, community network, or even the student himself/herself to provide information via one or more of the computing devices 106-112 to the counseling platform 102. In some embodiments, in addition to the questionnaires or surveys, the counseling platform 102 may data mine desired information about the student from various networks, systems, and sub-systems (if available). As such, the counseling platform 102 may establish a complete profile of the student based on available information or as information becomes available, and determine the types of problems that he/she may be experiencing, familial background information, life experiences, traumatic experiences, resources, etc., all of which may be considered to generate a treatment strategy as will be described in more detail below.

In some embodiments, a student may utilize a portable computing device, such as a smartphone or a tablet, running a student application, browser, and the like, with a GUI configured to communicate with the counseling platform 102.

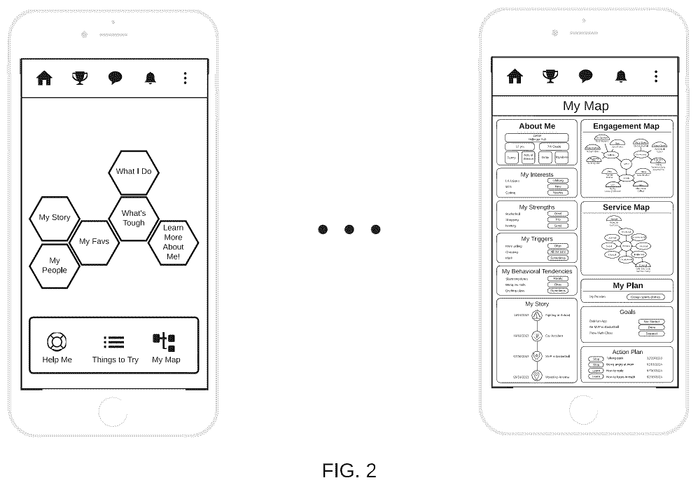

FIG. 2 depicts examples of a student application GUI, according to one or more embodiments of the present disclosure. The student application GUI may provide a convenient way for the student to manage their treatment and course of dealing with the coaches. The student may utilize the application to input information about himself/herself to the counseling platform by answering, for example, the above-mentioned questionnaires and/or surveys to build a life map. Once the life map is built and the coach generates and assigns an individualized treatment program, the coach may send (e.g., push via the application) information about his/her goals and other information related to their individualized treatment strategy so that the student has a convenient way to access that information, set reminders, monitor progress, and even send messages to the coach.

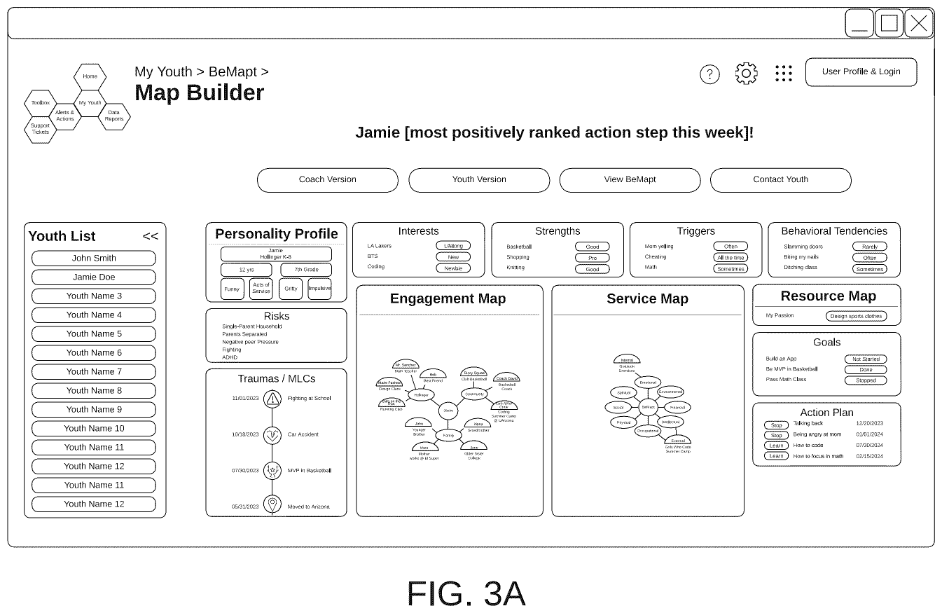

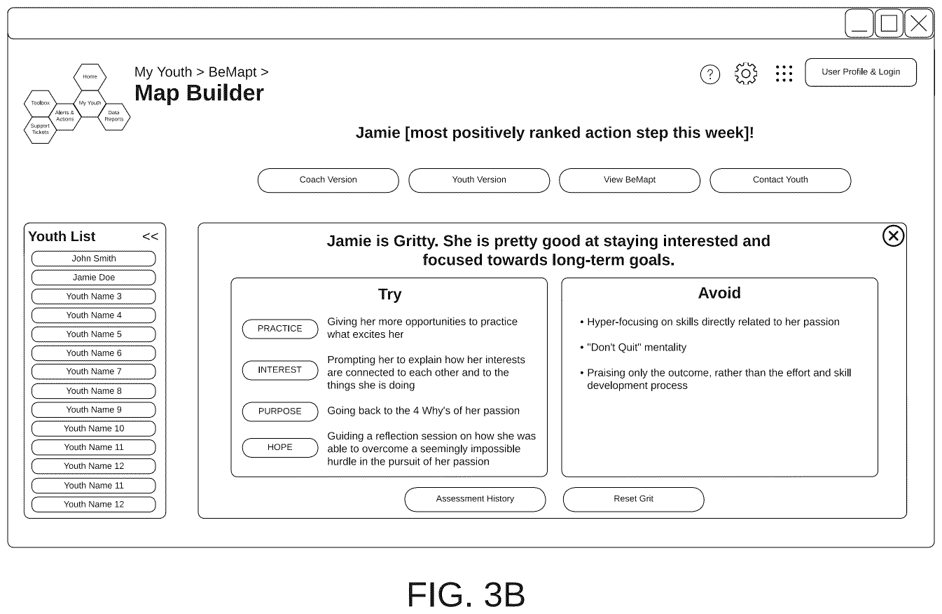

FIGS. 3A and 3B depict examples of an application with a GUI that may be utilized by the coach, according to one or more embodiments. Like the student application GUI, the application GUI for the coach may be utilized to access information related to the student and his/her treatment strategy from the coach's perspective. Thus, the coach may utilize the application GUI to view the student's profile, skills, goals, and the like provided by the student and the other networks (e.g., friends, school, family, etc.). The coach may also review the treatment strategy and recommendations provided by the counseling platform 102, and take an action based on the recommendations, or in some instances, ignore the recommendations entirely to generate a different treatment strategy based on the coach's expertise. The coach may then set the selected treatment strategy in the application GUI so that the student can see the treatment strategy from the student's application GUI. For example, if the treatment strategy requires the student to accomplish a certain task on a certain day, the coach may send a reminder from the coach's application GUI to the student's application GUI so that the student will not forget to accomplish the task. Accordingly, the coach may monitor the student's progress toward his/her treatment strategy so that adjustments may be made if desired or necessary.

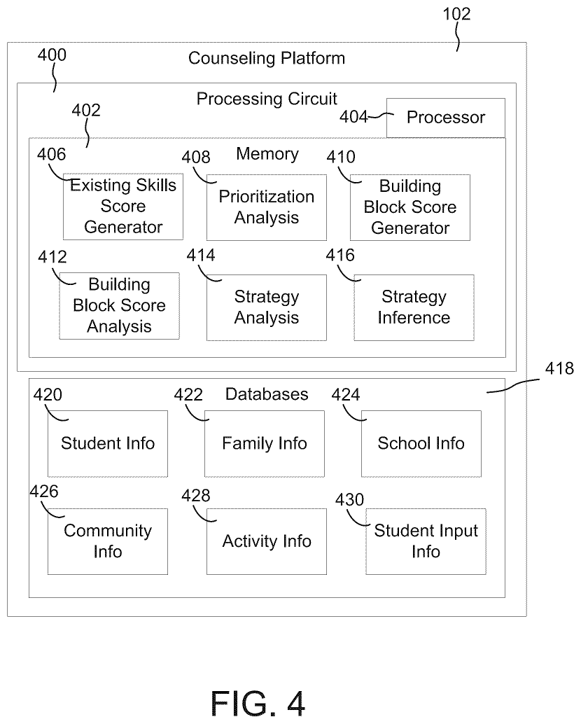

FIG. 4 is a block diagram of an example counseling platform 102, according to some embodiments. The counseling platform 102 may include one or more processing circuits 400 including one or more processors 404 and memory 402. Each of the processors 404 may be a general purpose processor or specific purpose processor, an application specific integrated circuit (ASIC), one or more field programmable gate arrays (FPGAs), a group of processing components, or other suitable processing components. Each of the processors 404 may be integrated within a single device or distributed across multiple separate systems, servers, or devices (e.g., computers). For example, each of the processors 404 may be an internal processor with respect to the counseling platform 102, or one or more of the processors 404 may be an external processor, for example, implemented as part of one or more servers or as a cloud-based computing system. Each of the processors 404 may be configured to execute computer code or instructions stored in the memory 402, and/or received from other computer readable media (e.g., CDROM, network storage, a remote server, databases and/or the like).

The memory 402 may include one or more devices (e.g., memory units, memory devices, storage devices, and/or the like) for storing data and/or computer code for performing and/or facilitating the various processes described in the present disclosure. The memory 402 may include random access memory (RAM), read-only memory (ROM), hard drive storage, temporary storage, non-volatile memory, flash memory, optical memory, or any other suitable memory for storing software objects and/or computer instructions. The memory 402 may include database components, object code components, script components, and/or any other kinds of information structures for supporting the various activities and information structures described in the present disclosure. The memory 402 may be communicably connected to the one or more processors 404 via the one or more processing circuits 400, and may include computer code for executing (e.g., by the one or more processors 404) one or more processes that will be described herein.

In some embodiments, the memory 402 may include an existing skills score generator 406, a prioritization analyzer 408, a building block score generator 410, a building black score analyzer 412, a strategy analyzer 414, and a strategy inference generator 416. In brief overview, the existing skills score generator 406 may take the inputs received from the student and the student's networks, and determine a numerical value for the inputs. Based on the determined numerical values, the existing skills score generator 406 may compute a score for one or more skills areas (e.g., agency, grit, and self-control skill areas), and the computer system may utilize this information to identify one or more skill areas in which the student may have a gap. The prioritization analyzer 408 may take the outcome from the existing skills generator 406, and determine a solution (e.g., the best way) to treat the skills gap based on whether the skill gap is an overall gap that is apparent across most areas of the student's life, or whether the skill gap is a situational gap where the skill gap is apparent in just a few areas of the student's life, or only in specific situations. Depending on whether the skill gap is overall or situational, the prioritization analyzer 408 may determine the solution for addressing these skill gaps, for example, through development of certain values or skills, focusing on the student's goals, or whether additional analysis should be performed to further determine other areas to address in the treatment process.

In some embodiments, a skill area may be made up of several building blocks, which correspond to that particular skill area. Accordingly, the building block score generator 410 may compute a score for each building block corresponding to the skill area based on the inputs received from the student and the student's network. Then, the building block score analyzer 412 may perform an analysis of the scores computed by the building block score generator 410 to determine, for example, which building blocks have the highest score or lowest score, which building blocks correspond to multiple skill areas, etc. The building block score analyzer 412 may then take the scores from the building block score generator 410 and perform an analysis to determine one or more skill area building blocks to develop. In some embodiments, the strategy analyzer 414 may generate a plurality of treatment strategies based on the determined skill area building blocks, and then consider an adoption rate of similar strategies by others, and a success rate by others that have adopted similar strategies to further narrow down the strategies to fewer recommendations. Based on this analysis, the strategy inference generator 416 may provide recommendations to the coach, who may then select one of the recommendations, or ignore the recommendations and generate an entirely different strategy.

In some embodiments, the counseling platform 102 may further include, or may be communicably connected to, a plurality of databases 418. The databases 418 may include storage units for storing information that is provided to the counseling platform 102 by the student and the student's networks including, but not limited to student information, family information, school information, community information, activity information, and student input information. The student's information that is stored in the databases 418 may be accessed by the existing skills score generator 406 to compute scores for the various information in the databases 418, in the manner briefly described above.

More particularly, the student information database 420 may receive and store information from a student information system, which may be accessed by people such as, for example although not limited to, school and school district staff, doctors, counselors, teachers, and the like, that may generate or have standardized plans such as an individualized education plan (IEP), a behavior plan (BP), and/or a multi-tiered system of support (MTSS) plan. Additionally, the student information system may upload information about the student's historical or recent behaviors, which may be stored at the student's school or at a counseling center, or by retrieving the student's grades and comments in their report cards.

A family information database 422 may receive and store information from the student's family via a family network. For example, information about the student's behavior, observations about the student, or the student's history (e.g., childhood incidents) may be provided from the student's family members through telephone conversations, emails, family consultations, and/or family coaching. This information may be provided by the family, for example, when the student is initially onboarded to the counseling platform 102 and/or the information may be provided on a continuous basis during the course of treatment of the student.

A school information database 424 may receive and store information from the student's school via a school network. For example, information about the student may be provided the teaches, administration staff, and/or a counselor visiting the student's classroom at school, communication or consultation with the student's teachers and staff, communication home through school-based platforms (e.g., Class Dojo, Remind), and/or from the meeting notes used to generate the IEP, BP, MTSS plans.

A community network database 426 may receive and store information from the student's community via a community network. The student's community network may include information from people in the student's social life and circle of friends, and the information may include behavioral health plan, child and family team meetings, community member consultations, communication home through community-based platforms (e.g., BAND, GroupMe, TeamSnap, WhatsApp, Discord).

An activity database 428 may receive and store information about the student related to the student's activities and assessments. Assessments may include questionnaires and surveys that are given to the student in which the student can answer, and the responses may be stored in the activity database 428. Assessments may include, for example, agency inventory, grit scale, impulsivity scale, One Word Entry, Love Language quiz, wellness inventory, trauma assessment, or stress scale.

A student input database 430 may receive and store information that are provided directly from the students about themselves. For example, the student may provide general background information about people in his/her life such as family members, school teachers, friends, and/or community members. The student may provide other personal information including a list of their interests such as their favorite foods, activities, and hobbies; significant events in his/her life such as moving, birth of a sibling, sibling going away for college, achievements, as well as hardships such as death of a family member; things he/she has a passion for or other involvements; things that bother him/her or bad habits he/she cannot overcome; things he/she wants to stop but cannot such as talking back or anger to certain people; and his/her strengths and weaknesses, behavioral tendencies, triggers, and passions; and goals or things he/she wants to learn. Accordingly, a profile of the student may be generated by the system based on the received information.

Accordingly, various inputs may be provided directly from the student. Furthermore, it should be noted that the inputs may be provided by the student and/or other parties (e.g., teacher, school staff, family, etc.) initially when the student's profile is initially created in the counseling platform 102 as well as on a continual basis. Thus, the student may wish to, or may be directed to, enter new or updated information whenever new incidents take place in his/her life or any new information comes to light. Similarly, other parties may enter new information about the student or update existing information as suitable also on a continual basis. Furthermore, it should be noted that the databases are not limited to only the above-described databases but the counseling platform 102 may include one or more other databases as well.

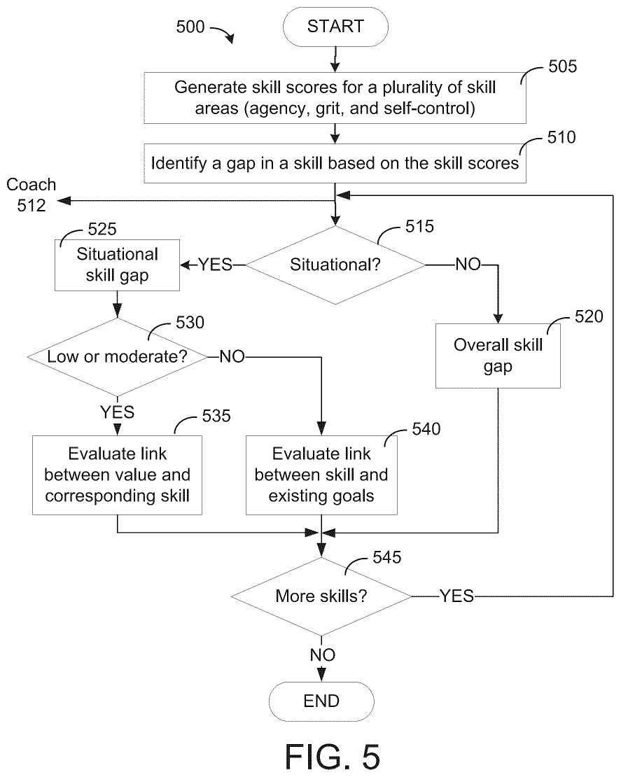

FIG. 5 is a flow chart of a method of identifying a gap in a skill according to one or more embodiments of the present disclosure (500). A skill gap, or a gap in a skill may be defined herein as one or more skill areas in which the student may fall short or lack, and therefore, may be improved through the development of a treatment strategy, according to the one or more embodiments of the present disclosure.

In some embodiments, the existing skills generator 406 may generate scores for various skill areas based on the information received and stored in the databases 418 (block 505). The skill areas may be separated into, for example, three areas including, but not limited to, an agency skill area, a grit skill area, and a self-control skill area. In the present disclosure, agency skill may be defined as a person's capacity to leverage resources to navigate obstacles to create positive change in their life; grit may be defined as passion and sustained persistence applied toward long-term achievement, with no particular concern for rewards or recognition along the way, or passion and perseverance for long-term goals; and self-control may be defined as the ability to do what's best for long-term goals, even when short-term temptations are present, or the ability to regulate behavior, attention, and emotions in the service of valued goals. Thus, the existing skills generator 406 may sort and analyze the information stored in the databases 418, determine how each of the responses, comments, reports, plans, and the like, from the databases 418 affect the skill areas, and compute a score (e.g., a numerical value) for each skill area based on that information. For example, the student's skill level in grit may be determined based on customized assessment questionnaires or other assessments developed by licensed practitioners well-known in the industry, such as Dr. Angela Duckworth's 12 question grit assessment. The results from such assessments may be used to determine the student's grit level and may be translated to a grit score. Other similar questionnaires and/or assessments may be used for determining other skill areas like agency and self-control. Accordingly, the score may indicate the student's strength and weaknesses in the skill areas, thus identifying whether the student has a gap in one or more skill areas (block 510).

In some embodiments, the score may utilize a numerical value of 1.0-5.0. A higher score may correspond to a higher propensity for that skill area, and a lower score may correspond to a lower propensity for that skill area. Therefore, for the agency and grit skills, a lower score may be indicative of a gap in agency or grit, whereas for self-control, a higher score may be indicative of higher impulsivity and thereby being indicative of a gap in self-control. In some embodiments, the scores may be divided into 4 groups: 1.0-1.9, 2.0-2.9, 3.0-3.9, and 4.0-5.0. Thus, a score in the range of 1.0-1.9 for the agency skill may indicate that the student has a relatively minimal agency; a score in the range of 2.0-2.9 may indicate that the student has a relatively low agency, a score in the rage of 3.0-3.9 may indicate that the student has a relatively moderate agency, and a score in the rage of 4.0-5.0 may indicate that the student has a relatively high agency. Thus, a student that has a relatively minimal or low agency may be flagged as having a gap in the agency skill area.

In some embodiments, a similar scoring technique may be implemented for grit and self-control. Thus, a student that has a score in the range of 1.0-1.9 may indicate that the student has a relatively minimal grit or minimal impulsivity; a score in the range of 2.0-2.9 may indicate that the student has a relatively low grit or impulsivity, a score in the rage of 3.0-3.9 may indicate that the student has a relatively moderate grit or impulsivity, and a score in the rage of 4.0-5.0 may indicate that the student has a relatively high grit or impulsivity. Accordingly, a student that has a relatively minimal or low grit may be flagged as having a gap in the grit skill area, and a student that has a relatively moderate or high impulsivity may be flagged as having a gap in the self-control skill area.

In some embodiments, the existing skill generator 406 may report the outcome to the student and the coach (block 512). For example, the student may be informed of their skill level (e.g., minimal, low, moderate, or high) for each skill area and also which of the skills is their biggest strength and which is the biggest gap. On the other hand, the coach may be provided with the same information as the student as well as additional information directed to the gapped skills. For example, the coach may be informed that the student has a gap in a particular skill area and whether that gap is moderate or high so that the coach may be able to determine the best way to treat or address this gap.

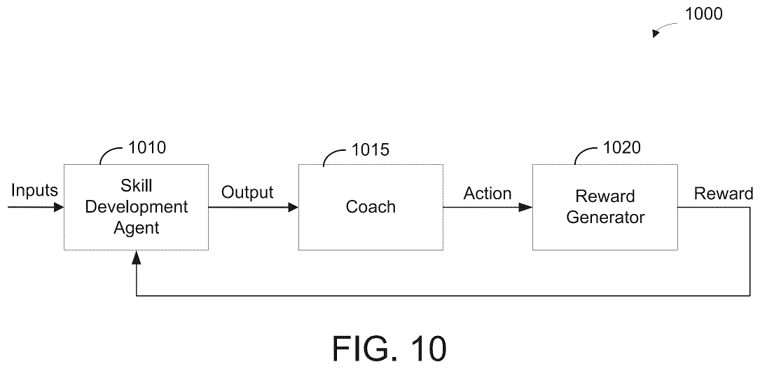

In some embodiments, the skill gaps determined by the existing skills score generator 406 may be improved through a continual machine learning system and methods, for example, as will be described with reference to FIGS. 10-12.

In some embodiments, further analysis may be performed for the gapped skill areas in order to generate an individualized treatment strategy for the student. Thus, for the skill areas that are gapped, a determination is made as to whether or not the gap is an overall gap or a situational gap (block 515). For example, the gap may be considered overall if the gap is seen across all or almost all areas of the student's life. Thus, if the student is flagged as having low grit, then some of the factors considered may include determining whether the low grit exists in more than one instance, whether a specific trend can be identified based on this low grit, and whether the initial or continuous score points are associated with the family network, school network, and multiple community engagement categories for the student. Therefore, if the low grit is exhibited across most or many areas of the student's life, such as in the family network, the school network, or the community network, then the priority analyzer 408 may determine that the low grit gap is an overall gap and not situational (block 520). When the gap is an overall gap, then prioritization is not an issue because the gap is the result of a true actual skill gap that is consistent across all or substantially all areas of the student's life, and not because of a value, cultural or familial issue that is interfering with the student's ability to use the skill.

On the other hand, the gap may be situational if the gap is exhibited in just one or only few areas of the student's life, or if specific trends are identified (block 525). For example, if the student exhibits low grit in only their family instances but not in the school or community networks, then the low grit gap may not actually be a true skill gap but instead, may be because of a value, cultural, or familial issue that is interfering with the student's ability to exercise this skill. Additionally, if the gap is situational, then the initial or continuous score is calculated based on no more than two of the family information network, school information network, or the multiple community engagement categories for the student. Therefore, if the gap is situational, then a prioritization analysis is further performed by the prioritization analyzer 408 by first determining whether the skill gap is a low or moderate gap (block 530). If the skill gap is low or moderate, then an evaluation is performed to determine a link between existing value (e.g., personal or religious value), cultural, or familial issue and the skill (i.e., agency, grit, self-control) (block 535). In other words, the prioritization analyzer 408 may determine whether certain values, cultural issues, or familial issues may be interfering with the skill area that is causing the student to have a gap instead of having an actual gap in the skill. If the skill gap is high for self-control or minimal for agency and grit, then an evaluation is performed to determine a link between the skill and the student's goals (block 540). The prioritization analysis may be repeated for each skill area that is identified as being gapped (block 545). Accordingly, a prioritization may be determined for the student's situational gap so that an appropriate treatment strategy may be created for the student.

Based on this outcome, the coach is informed whether the skill gap is overall or situational. If the skill is overall, then the coach is informed that the skill gap is not related to value, and thus, skills scaffolding may be recommended. If the skill is situational, then the coach is informed as to which situation the skill gap is tied to, and then the degree of the values gap (e.g., low, moderate, high) associated with this skill. For example, the coach may be informed as to the particular value, cultural, or familial issue that is interfering with utilizing the identified gapped skill, and the circumstances and/or the reasons for such interference. In some embodiments, if the value, cultural, or familiar issues is low or moderate, the coach may be recommended to develop value and skills, whereas if it is high, then the coach may be recommended to link the skill to the student's goal.

In some embodiments, the prioritization determined by the prioritization analyzer 408 may be improved through a continual machine learning system and methods, for example, as will be described with reference to FIGS. 10-12.

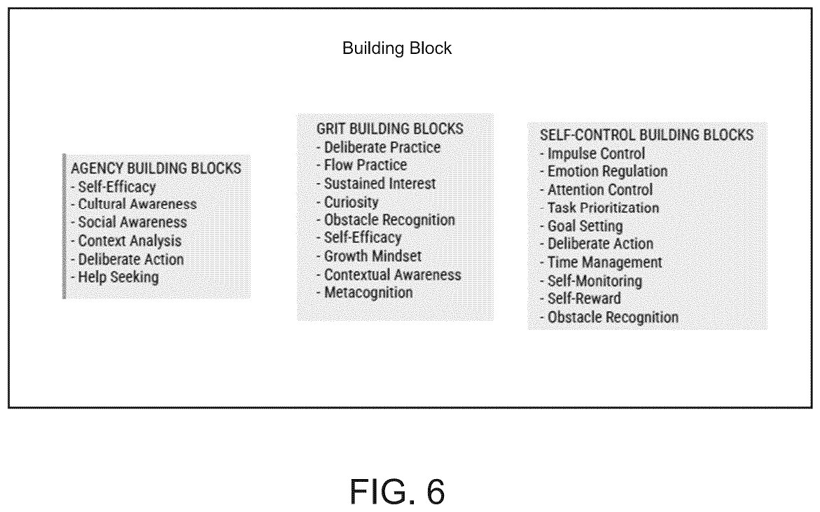

FIG. 6 is a block diagram illustrating individual building blocks that make up a building block for each skill area, according to one or more embodiments. For example, the agency building block may include self-efficacy, cultural awareness, social awareness, context analysis, deliberate action, and help seeking building blocks; the grit building block may include deliberate practice, flow practice, sustained interest, curiosity, obstacle recognition, self-efficacy, growth mindset, contextual awareness, and metacognition building blocks; and the self-control building block may include impulse control, emotion regulation, attention control, task prioritization, goal setting, deliberate action, time management, self-monitoring, self-reward, and obstacle recognition building blocks. By evaluating the individual building block for each skill area, specific areas within the skill area may be pinpointed as the source of the gap. That is, the building block score generator 410 and the building block score analyzer 412 may determine more specifically which parts of agency, which part of grit, and/or which part of self-control are the underlying issues for this student. Therefore, an individualized treatment strategy may be generated based at least on these outcomes.

The individual building blocks will now be defined in more detail. The self-efficacy building block is a person's belief in their ability to complete a task or achieve a goal, and includes confidence in their ability to control their behavior, influence their environment, and stay motivated. The cultural awareness building block is the person's ability to recognize and respect the differences and similarities between cultures, and involves understanding how culture impacts people's identities, lifestyles, and mental and physical health. The social awareness building block is the ability to understand and empathize with others, including those from different backgrounds and cultures. The context analysis building block is a method to analyze the environment in which something operates. The deliberate action building block is an action that has been planned or decided upon beforehand. The help seeking building block is a coping process that includes seeking external assistance to deal with a concern. The deliberate practice building block is a purposeful and systematic practice that involves effort and is intended to improve performance. The flow practice building block is a mental state where a person is completely immersed in an activity. The sustained interest building block is a person's ability to maintain a long-term, ongoing level of interest in something. The curiosity building block is a person's desire to learn or know more about something. The obstacle recognition building block is a person's ability to find and detect barriers in the path of a process. The growth mindset building block is a person's belief that abilities can be improved through effort, learning, and persistence. Contextual awareness is the person's ability to gather information about its environment at any given time and adapt behaviors accordingly. Metacognition is a person's ability to think about one's own thinking, and it involves understanding and assessing one's understanding and performance, as well as planning, monitoring, and controlling one's cognitive processing. The impulse control building block a person's behavioral condition that makes it difficult to control his/her actions or reactions. The emotion regulation building block is the person's ability to control his/her emotional state. The attention control building block is a person's capacity to choose what they pay attention to and what they ignore. The task prioritization building block is a person's ability to decide which tasks are most important and taking care of them first. The goal setting building block is a person's ability to develop an action plan to guide a person toward a goal. The time management building block is a person's ability to plan and control how much time to spend on specific tasks. The self-monitoring building block is a personality trait that involves the ability to monitor and regulate self-presentations, emotions, and behaviors in response to social environments and situations. The self-reward building block is a person's ability to appreciate his/her own achievements or efforts, rewarding himself/herself for appropriate behavior or achieving a desired goal. It should be noted that the above-described building blocks are provided as examples and other building blocks may be added or removed from the skills. Furthermore, some of the building blocks may fall under more than one skill. For example, both agency and grit skills include self-efficacy as one of the building blocks.

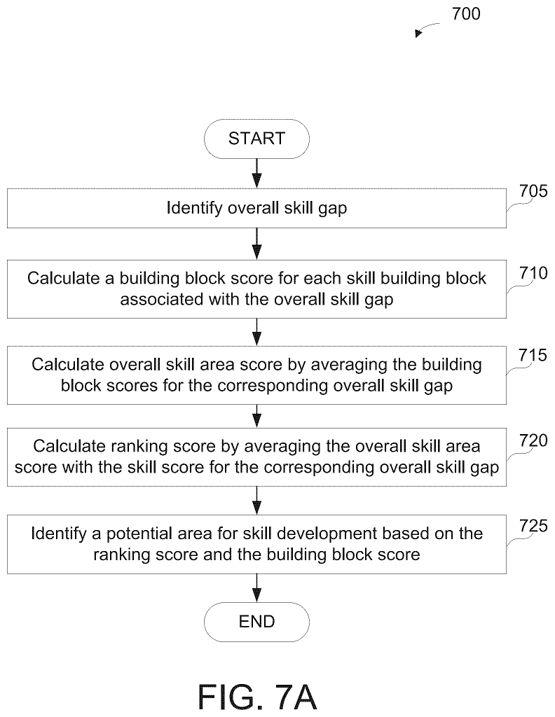

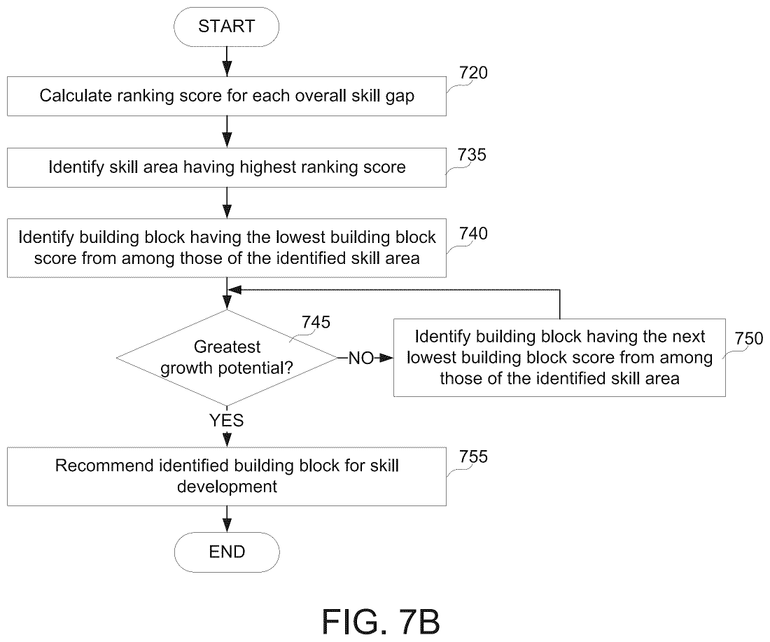

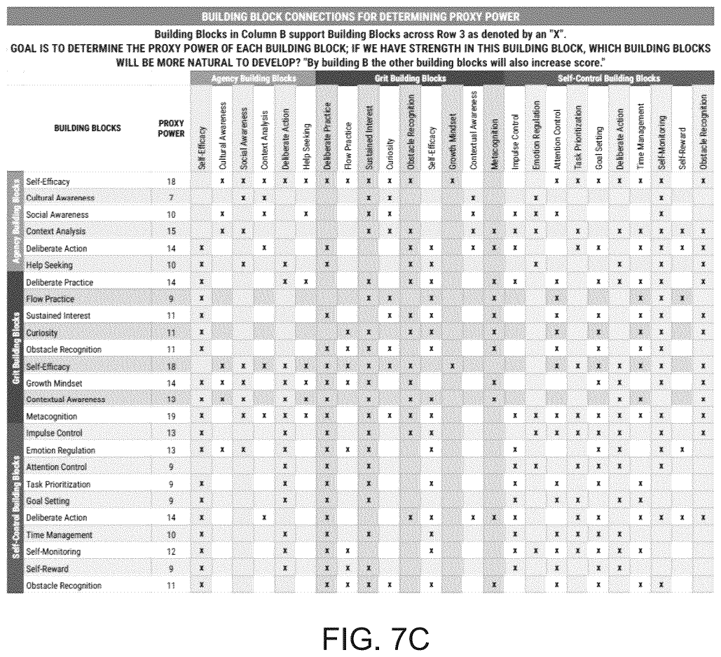

FIGS. 7A and 7B are flow diagrams of a method of selecting a building block skill for skill development according to one or more embodiments. In some embodiments, the building block score generator 410 may first identify a skill area that was previously determined by the prioritization analyzer 408 as being an overall skill area gap (block 705). Next, the building block score generator 410 may calculate building block score (e.g., a numerical value) for each skill building block associated with the overall skill gap (block 710). For example, if the agency skill area is identified as an overall skill area with a gap, then a score for each of the individual building blocks including the self-efficacy, cultural awareness, social awareness, context analysis, deliberate action, and help seeking building blocks, all corresponding to the agency building block are calculated by the building block score generator 410. A numerical value in the range of 1.0-5.0 may be assigned to the individual building blocks corresponding to each skill area, and a score in the range of 1.0-2.3 may be considered a relatively low level building block score; a score in the range of 2.4-3.7 may be considered a relatively moderate level building block score; and a score in the range of 3.8-5.0 may be considered a relatively high building block score. Next, an overall skill area score may be calculated by the building block score generator 410 by averaging the individual building block scores for the corresponding overall skill area with the gap (block 715). Thus, in the above example, an average of the individual scores for the self-efficacy, cultural awareness, social awareness, context analysis, deliberate action, and help seeking building blocks may be calculated. Next, a ranking score may be determined by averaging the overall skill area score with the skill area score for the corresponding overall skill gap (as calculated by the existing skills score generator 406) (block 720). Finally, a potential area for skill development (i.e., the targeted skill development area) may be identified based on the ranking score and the building block score (block 725). In some embodiments, new information about the person may be continuously received, and therefore the skill area score may be continuously updated based on this information.

Turning to FIG. 7B, the skill area having the highest ranking score as calculated at block 720 is identified (block 735), and then the building score corresponding to the lowest individual building block score from among the identified skill area is identified (block 740). In other words, the individual building block with the lowest building block score out of the highest ranking score skill area is determined. Next, the identified individual building block is evaluated to determine whether it has the greatest growth potential (block 745), and if so, then that building block may be recommended for skill development (block 755). If not, then the next lowest individual building block score from among the identified skill area is determined (block 750), until a building block with the greatest growth potential is identified. Greatest growth potential may be defined as a building block with the lowest score that supports other building blocks across a number of skill areas (e.g., all three skill areas). For example, the greatest potential may be the building block with the lowest scores and the building block having the highest proxy power score. Proxy power score may be computed by determining the number of applicable building blocks across the skill areas. And example of a proxy power chart is illustrated in FIG. 7C. Therefore, in some embodiments, the building block with the least resistance (e.g., based on building block resistance scores) may be the building block that has the lowest building block score in the second highest ranked skill area (i.e., a rank of 2) instead of the highest ranked skill area depending on the overall score and overlap with the most growth potential. Based on the analysis and the computation, the building block analyzer 412 may provide the coach with a recommended building block for skill development. The information provided to the coach may include information as to which of the skill areas is the lowest, moderate, and highest, with a corresponding skill area score. Additionally, for each skill area, the name of the building block with a corresponding score for each building block, and the building blocks sorted in order from the lowest to the highest with their corresponding indicators, low, moderate, and high.

In some embodiments, the potential skill area and the building blocks for skill development determined by the building block score generator 410 and the building block score analyzer 412 may be improved through a continual machine learning system and methods, for example, as will be described with reference to FIGS. 10-12.

In some embodiments, the outputs from the building block analyzer may also be provided to a second continual machine learning system. The second continual machine learning system may be trained to combine the outputs from the building block analyzer with an analysis of wellness gaps from the given inputs to generate, for example, top three suggested external strategies to support the student. External strategies may include programs, interventions, and/or services that students may join or receive at a given location. The ranking of external strategies may be based on how well the strategy supports the lowest hanging fruit building block and the flagged wellness gap, how well the strategy capitalizes on the building block strengths, how likely the organization providing the strategy is to address the flagged wellness gap, and how well the strategy fits with the student's interests, personality, existing supports, and trends. In some embodiments, the second continual machine learning system may also consider the student's preferred or desired location, e.g., specific minutes away from the student's school, home, neighborhood, or other specified locations, the student's mode of transportation, the student's existing schedule to avoid schedule conflicts, existing transportation routes based off of the student's existing schedule, existing resource databases such as 2-1-1, and the student's profile group. Accordingly, the outputs may be provided to various other machine learning systems to provide other analysis and recommendations to further help the student overcome his/her skill gaps.

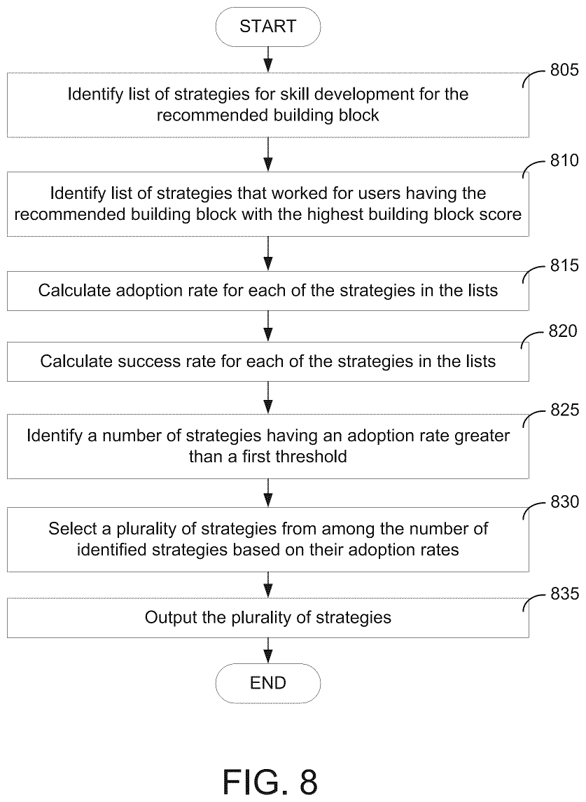

FIG. 8 is a flow chart of a method of recommending a plurality of strategies, according to one or more embodiments. In some embodiments, the strategies may include “internal strategies,” which include self-help strategies, tools, techniques, and exercises, that help the students develop the gapped skill areas. Thus, internal strategies may be different from “external strategies,” which utilize outside help such as, relying on programs, interventions, and services that help the student cope with and ultimately develop the gapped skills. In some embodiments, external strategies may be generated based on the output from the building block score analyzer 412 and additional information and analysis such as wellness gaps.

In some embodiments, a plurality of best internal strategies may be generated and recommended to the coach based on the outcome of the building block score analysis performed by the building block analyzer 412. Thus, the strategy analyzer 414 and the strategy inference generator 416 may identify a first list of strategies that develop skills for the building blocks that were recommended for development by the building block analyzer 412 (block 805). Additionally, the strategy analyzer 414 and the strategy inference generator 416 may identify a second list of strategies that worked for students having the recommended building block with the highest building block score (block 810). In other words, another list of strategies may be identified based on strategies that worked for students (e.g., other student that have undergone treatment) who's skills for the above-recommended building block (i.e., the building block with the highest building block score) have been developed. Next, out of the first list and the second list of strategies identified above, the number of strategies may be narrowed down to the top choices by calculating an adoption rate for each of the strategies in the first list and the second list (block 815), and calculating a success rate for each of the strategies in the first list and the second list (block 820). In some embodiments, an adoption rate may be defined as the likelihood of the student accepting the strategy and actually following the instructions or guidance that may be determined by the strategy to develop the skills. Success rate may be defined as the rate of success of other students that actually adopted the strategy in developing the skills. Thus, a number of strategies having an adoption rate greater than a first threshold is identified (block 825), then a plurality of strategies from among the number of identified strategies based on their adoption rates may be identified (block 830). Thus, in some embodiments, a suitable adoption rate threshold may be set by the coach, for example, a threshold of 75% adoption rate such that only the strategies that have historically had an adoption rate of greater than 75% is selected. Similarly, a threshold may be set for the success rate such that only the strategies that have historically had a success rate of greater than some set threshold, e.g., 80%, is selected. Based on the new list that now includes only the top strategies selected based on satisfying the set adoption rate and success rate thresholds, the top strategies (e.g., the top three strategies) may be provided to the coach as the recommended strategies (block 835).

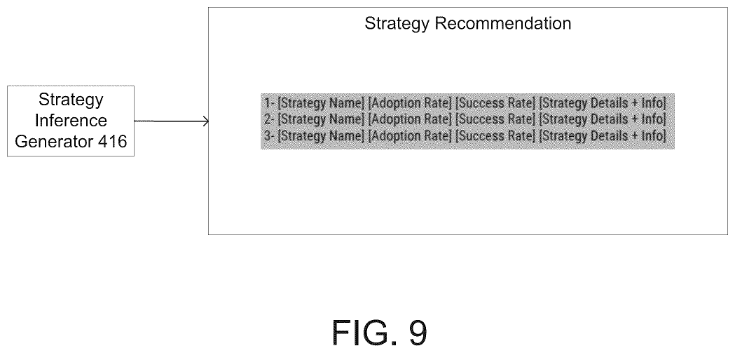

FIG. 9 illustrates the plurality of strategies output to the coach as recommendations from the strategy inference generator 416, according to one or more embodiments. Therefore, the coach may review the strategies recommended by the counseling platform 102, and select one or more of the recommended strategies to pursue with the student, or the coach may decide to deviate from the recommendation and implement other strategies based on the coach's expertise and the generated scores. In some embodiments, each of the recommended strategies may include information that may be helpful to the coach in deciding whether or not to accept the recommendations. The information may include the specific strategy, the adoption rate of this strategy, the success rate of this strategy, and additional details for this strategy such as the steps that the coach may take in treating the student. Accordingly, the coach may guide and/or treat the student by implementing strategies that consider all of the various information provided about the student into the counseling platform 102, as well as based on the coach's expertise.

In some embodiments, the recommendations generated by the strategy analyzer 414 and the strategy inference generator 416 may be improved through a continual machine learning system and methods, for example, as described next with reference to FIGS. 10-12.

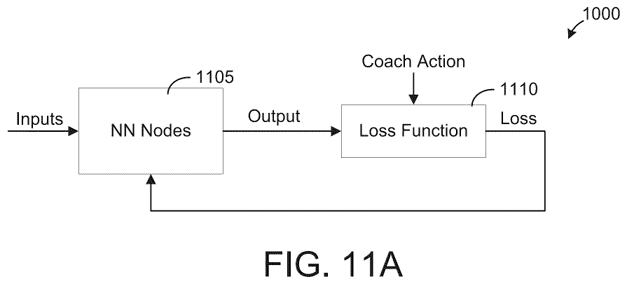

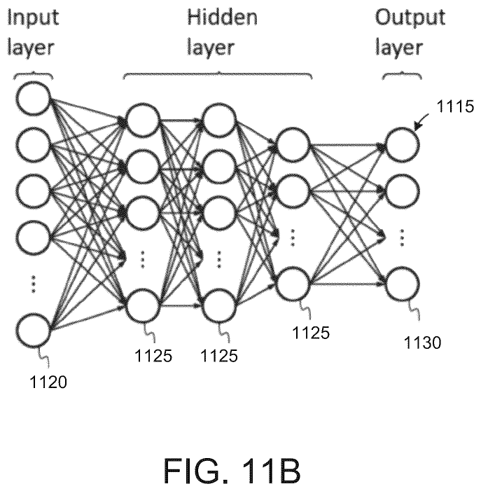

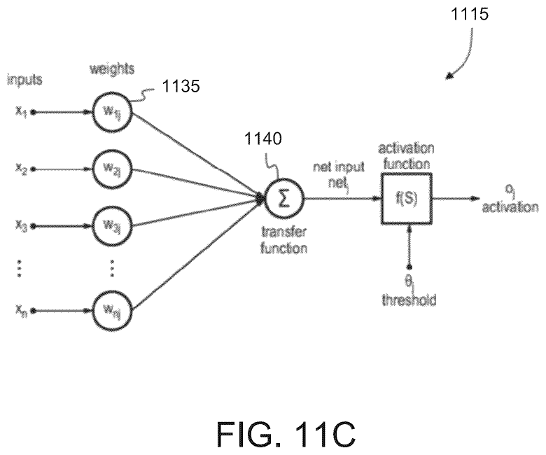

FIG. 10 is a block diagram of a machine learning system, according to one or more embodiments. The machine learning system 1000 may include a skill development agent 1010, a coach 1015, and a reward generator 1020. Each of the skill development agent 1010 and the reward generator 1020 may be implemented, for example, as instructions stored in memory and executed by one or more processors (e.g., the processor 404 shown in FIG. 4). The skill development agent 1010 may be configured to receive inputs (e.g., the set of inputs associated with the questionnaires, surveys, and the like), generate an output that is received by the coach 1015, who then causes an action (e.g., a recommendation actually provided or selected) that is observed by the reward generator 1020. The reward generator 1020 may then output a reward based on the action, and the reward may be fed back to the skill development agent 1010 as another input (i.e., feedback). Applying the machine learning system 1000 to the counseling platform 102 described above, the inputs may correspond to information such as those stored in the databases 418 of the counseling platform 102, and the skill development agent 1010 may correspond to the existing skills score generator 406, a prioritization analyzer 408, a building block score generator 410, a building black score analyzer 412, a strategy analyzer 414, and/or a strategy inference generator 416 described earlier with reference to FIG. 4. Therefore, the skill development agent 1010 may generate a strategy recommendation that is received by the coach 1015, who may then implement the strategy as an action to the student (i.e., which is observed by the reward generator 1020). In some embodiments, the strategy may be based on at least training and building block scores, building block resistance scores, and/or building block proxy scores. The student may then produce a result, for example, the student may or may not adopt the strategy, or the strategy may or may not be a success for the student. These results may be provided back to the skill development agent 1010 as a reward from the reward generator 1020. Accordingly, the skill development agent 1010 may include a continual feedback from the reward generator so that the skill development agent 1010 may continually improve the output that it generates and provides to the coach 1015. In some embodiments, a continual machine learning system may be implemented with an artificial neural network as shown in FIGS. 11A-11C.

FIG. 11A is a diagram of an artificial neural network system during training, according to one or more embodiments. Referring to FIG. 11A, an artificial neural network system 1000 may include one or more processing circuits including one or more processors and memory. Each of the processors may be a general-purpose processor or specific-purpose processor, an application specific integrated circuit (ASIC), one or more field programmable gate arrays (FPGAs), a group of processing components, or other suitable processing components. Each of the processors may be integrated within a single device or distributed across multiple separate systems, servers, or devices (e.g., computers). For example, each of the processors may be an internal processor with respect to the artificial neural network system 1000, or one or more of the processors may be an external processor, for example, implemented as part of one or more servers or as a cloud-based computing system. Each of the processors may be configured to execute computer code or instructions stored in the memory, and/or received from other computer readable media (e.g., CDROM, network storage, a remote server, and/or the like).

The memory may include one or more devices (e.g., memory units, memory devices, storage devices, and/or the like) for storing data and/or computer code for performing and/or facilitating the various processes described in the present disclosure. The memory may include random access memory (RAM), read-only memory (ROM), hard drive storage, temporary storage, non-volatile memory, flash memory, optical memory, or any other suitable memory for storing software objects and/or computer instructions. The memory may include database components, object code components, script components, and/or any other kinds of information structures for supporting the various activities and information structures described in the present disclosure. The memory may be communicably connected to the one or more processors via the one or more processing circuits, and may include computer code for executing (e.g., by the one or more processors) one or more of the processes described herein.

The one or more processors and the memory of the artificial neural network system 1000 may implement a plurality of neural network (NN) nodes or neurons 1105 (e.g., DNN nodes or neurons) that are trained to output a prediction (e.g., a strategy recommendation). During training, the neural network nodes 1105 may output the prediction based on training data, and the one or more processors may calculate a loss based on a loss function 1110 between a coach action (e.g., the coach action label) of the training data and the output (e.g., the output label) from the neural network nodes 1105. As illustrated in FIG. 11A, the calculated loss may be used to adjust parameters (e.g., weights) used by the neural network nodes 1105 to output a suitable prediction that reduces or minimizes the loss calculated based on the loss function 1110.

FIG. 11B is a diagram of an artificial neural network, and FIG. 11C is a diagram of a neuron of the artificial neural network, according to one or more embodiments. Referring to FIGS. 11B and 11C, the artificial neural network system includes a plurality of neural network nodes or neurons 1115. The neural network nodes 1115 form an input layer 1120, one or more hidden layers 1125, and an output layer 1130. A plurality of connections may be formed between the neural network nodes 1115, for example, as illustrated in FIG. 11B. A weighted sum (or “linear combination”) of the inputs is formed (e.g., each input is multiplied by a respective weight or parameter 1135, and the sum 1140 of these products is formed) as illustrated in FIG. 11C. The weighted sum is processed by an activation function f(S), which may be any suitable nonlinear function (e.g., DNN function), for example, such as a nonlinear thresholding function.

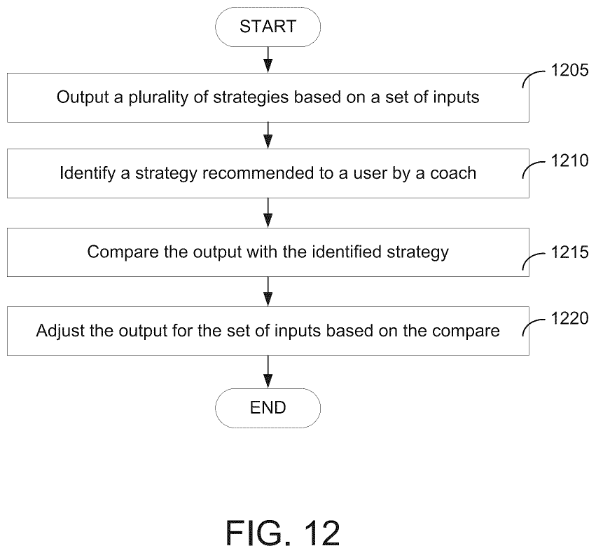

FIG. 12 is a flow chart of a continual machine learning method, according to one or more embodiments. According to the machine learning method, the counseling platform 102 including a machine learning system may output a plurality of strategies based on a set of inputs (block 1205). For example, the strategies may correspond to the internal strategies generated by the strategy analyzer 414 and the strategy inference generator 416 of the counseling platform 102 and recommended to the coach. The inputs may correspond to the various information about the student stored in the databases 418. Next, the system may identify a strategy recommended to the student by the coach (block 1210), and the output (e.g., recommended strategies by the strategy analyzer 414 and the strategy inference generator 416) may be compared with the identified strategy (i.e., the actual strategy that was selected by the coach to implement for the student), whether the student actually adopted the strategy, and the student's success rate in executing the strategy (block 1215). Such comparisons may be determined through the reward or the loss function of the machine learning system (see FIGS. 10-11). Based on this comparing, the output may be adjusted for the set of inputs (block 1220). Accordingly, a machine learning system may be trained with past data (e.g., from other students that have gone through this counseling program) including information such as the internal strategies adoption and success rate, information about the student (e.g., the information in the databases 418). Therefore, the machine learning system may become more intelligent over time so that future recommendations are continually improved. Thus, the strategy recommendations by the machine learning system may generate better recommendations than would a coach be able to recommend based on a manual analysis and generation of strategies.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments described herein are examples only. One skilled in the art may recognize various alternative embodiments from those specifically disclosed. Those alternative embodiments are also intended to be within the scope of this disclosure. As such, the embodiments are limited only by the following claims and their equivalents.

### Definitions of Some Terms Used

Skill Area—A category of skills that may be defined as Agency, Grit, or Self-Control.

Skill Building Block—Smaller skills that may make up the larger skill area of agency, grit, or self-control. May be defined as Self-Efficacy, Cultural Awareness, Social Awareness, Context Analysis, Deliberate Action, Help Seeking, Deliberate Practice, Flow Practice, Sustained Interest, Curiosity, Obstacle Recognition, Growth Mindset, Contextual Awareness, Metacognition, Impulse Control, Emotion Regulation, Attention Control, Task Prioritization, Goal Setting, Time Management, Self-Monitoring, Self-Reward.

Initial Score—Score that may range from 1 to 5 calculated based on Skill Area inventories/scales—Agency Inventory, Grit Scale, Impulsivity Scale. There may be an Initial Score for each of the 3 Skill Areas. The Initial Score may be calculated only once per user, unless the Skill Area inventories/scales are reset.

Continuous Score—Score made from the Initial Score and points added or subtracted based on other inputs as they become available through user and API input. There may be a Continuous Score for each of the 3 Skill Areas. This may be continuously calculated after each significant user and API input (for example, through a machine learning, natural language processing model). This may be used to determine the Skill Area Level of minimal, low, moderate, or high.

Building Block Score—Score that may range from 1 to 5 based on Skill Area inventories/scales, and other user and API inputs-like additionally assigned inventories/scales/activities. There may be a Building Block Score for each of the 22 Skill Building Blocks. This may be continuously calculated after each significant user and API input (for example, through a machine learning, natural language processing model). This may be used to determine the Building Block Skill Level of low, moderate, or high.

Overall Skill Area Score—Score that may range from 1 to 5 calculated from the average of the Building Block Scores within each Skill Area. There may be an Overall Skill Area Score for each of the 3 Skills Areas. This may be continuously calculated after each significant user and API input (for example, through a machine learning, natural language processing model).

Overall Skill Rank—Whole number rank that may range from 1 to 3 determined from an average of the Overall Skill Score and the Continuous Score. There may be an Overall Skill Rank for each of the 3 Skill Areas. The averages for each Skill Area may be ordered from lowest to highest, for example, assigned 1 for the lowest average, 2 for the middle average, and 3 for the highest average. This may be continuously calculated after each significant user and API input (for example, through a machine learning, natural language processing model).

What is claimed is:

1. A system comprising:
a processor; and
a memory storing instructions executed by the processor to cause the processor to:
generate a skill area score for each skill area of a plurality of skill areas based on received inputs;
identify a skill gap in a skill area of the plurality of skill areas based on the skill area score;
determine that the skill gap is an overall skill gap;
calculate a building block score for each skill building block of the plurality of skill building blocks associated with the overall skill gap; and
generate a recommendation for a strategy corresponding to the identified skill gap based on the building block score.

2. The system of claim 1, wherein the instructions further cause the processor to:
continuously update the skill area score based on newly received inputs;
calculate an overall skill area score by averaging the building block score corresponding to each skill building block associated with the overall skill gap; and
calculate a ranking score by averaging the overall skill area score with the skill area score corresponding to the overall skill gap.

3. The system of claim 2, wherein the instructions further cause the processor to:
identify a target development skill based on the ranking score and the building block score.

4. The system of claim 2, wherein the instructions further cause the processor to:
identify the skill area corresponding to the highest ranking score;
identify the skill building block corresponding to the lowest building block score from among the plurality of skill building blocks of the identified skill area; and
assign the identified skill building block as a recommended skill building block for a target development skill, in response to determining that the identified skill building block is a skill building block related to a number of skill areas of the plurality of skill areas.

5. The system of claim 4, wherein to generate the recommendation for the strategy, the instructions further cause the one or more processors to:
generate a first set of strategies based on the plurality of skill building blocks corresponding to a first criteria;
generate a second set of strategies based on the plurality of skill building blocks corresponding to the highest building block score;
calculate an adoption rate for each of the strategies generated in the first set of strategies and the second set of strategies; and
identify a number of strategies from among the strategies generated in the first set of strategies and the second set of strategies corresponding to the adoption rate being greater than a set adoption rate threshold.

6. The system of claim 5, wherein the instructions further cause the processor to:
calculate a success rate for each of the strategies generated in the first set of strategies and the second set of strategies; and
identify a number of strategies from among the identified number of strategies corresponding to the success rate being greater than a set success rate threshold.

7. The system of claim 6, wherein the processor implements machine learning that is trained based on datasets corresponding to the adoption rate and the success rates, and the instructions further cause the processor to:
generate the recommendation of the strategy based on at least training and the building block score.

8. The system of claim 7, wherein the dataset corresponding to the adoption rate is based on a likelihood of a recommendation being an accepted strategy, and
wherein the dataset corresponding to the success rate is based on a likelihood of an adopted strategy being a success.

9. The system of claim 1, wherein:
the skill areas comprise an agency skill area, a grit skill area, and a self-control skill area;
the skill area score comprises a range of 1.0 to 5.0; and
the building block score comprises a range of 1.0 to 5.0.

10. A method comprising:
generating, by a processor, a skill area score for each skill area of a plurality of skill areas based on received inputs;
identifying, by the processor, a skill gap in a skill area of the plurality of skill areas based on the skill area score;
determining, by the processor, that the skill gap is an overall skill gap;
calculating, by the processor, a building block score for each skill building block of the plurality of skill building blocks associated with the overall skill gap; and
generating, by the processor, a recommendation for a strategy corresponding to the identified skill gap based on the building block score.

11. The method of claim 10, further comprising:
continuously updating, by the processor, the skill area score based on newly received inputs;
calculating, by the processor, an overall skill area score by averaging the building block score corresponding to each skill building block associated with the overall skill gap; and
calculating, by the processor, a ranking score by averaging the overall skill area score with the skill area score corresponding to the overall skill gap.

12. The method of claim 11, further comprising:
identifying, by the processor, a target development skill based on the ranking score and the building block score.

13. The method of claim 11, further comprising:
identifying, by the processor, the skill area corresponding to the highest ranking score;
identifying, by the processor, the skill building block corresponding to the lowest building block score from among the plurality of skill building blocks of the identified skill area; and
assigning, by the processor, the identified skill building block as a recommended skill building block for a target development skill, in response to determining that the identified skill building block is a skill building block for a number of skill areas of the plurality of skill areas.

14. The method of claim 13, wherein the generating of the recommendation for the strategy comprises:
generating, by the processor, a first set of strategies based on the plurality of skill building blocks corresponding to a first criteria;
generating, by the processor, a second set of strategies based on the plurality of skill building blocks corresponding to the highest building block score;
calculating, by the processor, an adoption rate for each of the strategies generated in the first set of strategies and the second set of strategies; and
identifying, by the processor, a number of strategies from among the strategies generated in the first set of strategies and the second set of strategies corresponding to the adoption rate being greater than a set adoption rate threshold.

15. The method of claim 14, further comprising:
calculating, by the processor, a success rate for each of the strategies generated in the first set of strategies and the second set of strategies; and
identifying, by the processor, a number of strategies from among the identified number of strategies corresponding to the success rate being greater than a set success rate threshold.

16. The method of claim 15, further comprising:
training, by the processor, a neural network with a dataset corresponding to the adoption rate and the success rate; and
generating, by the processor, the recommendation for the strategy based on at least training of the neural network and the building block score.

17. The method of claim 16, wherein the dataset corresponding to the adoption rate is based on a likelihood of a strategy being an accepted strategy, and
wherein the dataset corresponding to the success rate is based on a likelihood of an adopted strategy being a success.

18. The method of claim 10, wherein:
the skill areas comprise an agency skill area, a grit skill area, and a self-control skill area;
the skill area score comprises a range of 1.0 to 5.0; and
the building block score comprises a range of 1.0 to 5.0.

19. A computer-readable medium storing instructions that, when executed by one or more processors, cause the one or more processors to perform a method comprising:
generating a skill area score for each skill area of a plurality of skill areas based on received inputs;
identifying a skill gap in a skill area of the plurality of skill areas based on the skill area score;
determining that the skill gap is an overall skill gap;
calculating a building block score for each skill building block of the plurality of skill building blocks associated with the overall skill gap; and
generating a recommendation for a strategy corresponding to the identified skill gap based on the building block score.

20. The computer-readable medium of claim 19, wherein the one or more processors implements a continual machine learning method comprising:
observing, by the processor, an implementation of a strategy corresponding to a state of the received inputs;
calculating, by the processor, a reward based on the recommendation for the strategy and the implementation of the strategy; and
adjusting, by the processor, the recommendation for the strategy for the state of the received inputs based on the reward.
